(19) United States
(12) Patent Application Publication
(10) Pub. No.: US 2003/0210768 A1
(43) Pub. Date: Nov. 13, 2003

(54) Manual and automatic record feature in a telephone

(76) Inventor: Rajeev Madhukar Sahasrabudhe, Fishers, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/143,666

(22) Filed: May 9, 2002

(51) Int. Cl. H04M 1/64; H04M 11/00

(52) U.S. Cl. 379/67.1; 379/88.14

(57) ABSTRACT

A communications device includes a transceiver coupled to a telecommunications network for transmitting and receiving conversational communications. A recording device is integrated into the transceiver, which can be activated in real-time to record the conversational communications such that the conversational communications can be played back while the transceiver is on-hook or off-hook. A record activation device is integrated into the transceiver to permit the activation of the recording device to selectively record portions of the conversational communications.

### FIELD OF THE INVENTION

The present invention generally relates to telephone devices and, more particularly, to a telephone having a record feature, wherein a user can record a telephone conversation by manually pressing a key or can configure the telephone to automatically record the conversation.

### BACKGROUND OF THE INVENTION

When attending a phone call, it is a common experience that information content relayed via telephone needs to be recorded for future use. For example, certain information derived from a telephone conversation, such as telephone numbers, addresses, etc., needs to be remembered quickly and the user needs to search for a pen and a paper in order to record the information. If pen and paper are not available then the party on the other side has to wait until the information can be written down or wait until the information is memorized. In addition, it is often cumbersome to take notes while holding a telephone.

Some telephones include answering machines that can record a caller's message. There is no technology where a call can be recorded in real-time during a conversation while talking on the telephone. There are technologies where telephones can be tapped by third parties to listen to others conversations. This is primarily used for surveillance and intelligence purposes. However, this does not assist a person in recording his or her own conversation. Other technologies exist where a recording device such as a dictaphone or tape recorder are employed to record a telephone conversation. These devices often suffer from background noise and are not often available. Institutions and businesses interested in monitoring quality of service and/or maintaining records of conversations do so by recording entire conversations for future review. These systems include complex switching devices and record keeping technologies far beyond the scope of general consumers.

Other devices, like headsets and hands free kits, aim to give the user freedom to do other tasks with their hands, for example, driving etc. These devices do not eliminate the need to take down information during a telephone conversation.

Therefore, a need exists for a recording device built into a telephone, which provides real-time conversation recording and playback.

### SUMMARY OF THE INVENTION

A communications device includes a transceiver coupled to a telecommunications network for transmitting and receiving conversational communications. A recording device is integrated into the transceiver, which can be activated in real-time to record the conversational communications such that the conversational communications can be played back while the transceiver is on-hook or off-hook. A record activation device is integrated into the transceiver to permit the activation of the recording device to selectively record portions of the conversational communications.

A method for recording a telephone conversation includes activating a recording device, which is integrated into a telephone to record a two-way conversation, identifying specific portions of the conversation being recorded by employing a speech recognition engine, and storing the specific portions of the conversation in memory locations.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a schematic diagram showing a communication device(s) with a recording feature in accordance with the present invention connected over a communications network;

FIG. 2 is a block diagram of an illustrative communication device(s) with a recording feature in accordance with one embodiment of the present invention; and

FIG. 3 is a block diagram of an illustrative method for employing the communication device(s) in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention provides a telephone device having a record feature. The record feature is included in the telephone, and a user can record a conversation or part of a conversation of a call by manually pressing a record key, configuring a telephone to automatically record the conversation or employing a voice-activated record mode. During a telephone conversation, a user simply activates the telephone record function and the telephone device records the two-way conversation of the phone call. The record mode can be terminated by deactivating the record mode or hanging up the telephone. The recorded conversation can be played back while the phone is on-hook or off-hook. In the off-hook mode, both the user recording and a person of the other end of the connection can listen to the recorded conversation.

In one embodiment, a speech to text converter is included in the telephone such that a textual record of the telephone call can be provided. This is particularly useful for professionals such as doctors or lawyers where a textual record of a telephone call would be beneficial. Advantageously, since information is transmitted and received, the text output could include which speaker uttered the text.

It is to be understood that the present invention is described in terms of a telephone system; however, the present invention is much broader and may include any digital multimedia telecommunications device, which is capable of message delivery over a switched network. In addition, the present invention is applicable to any system over which conversational communications are made, for example, telephones, computers, TTY, etc. The present invention is described in terms of a telephone network; however, the concepts of the present invention may be extended to cable, wireless, DSL, external networks, local area networks, (LAN), satellite or other network types.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

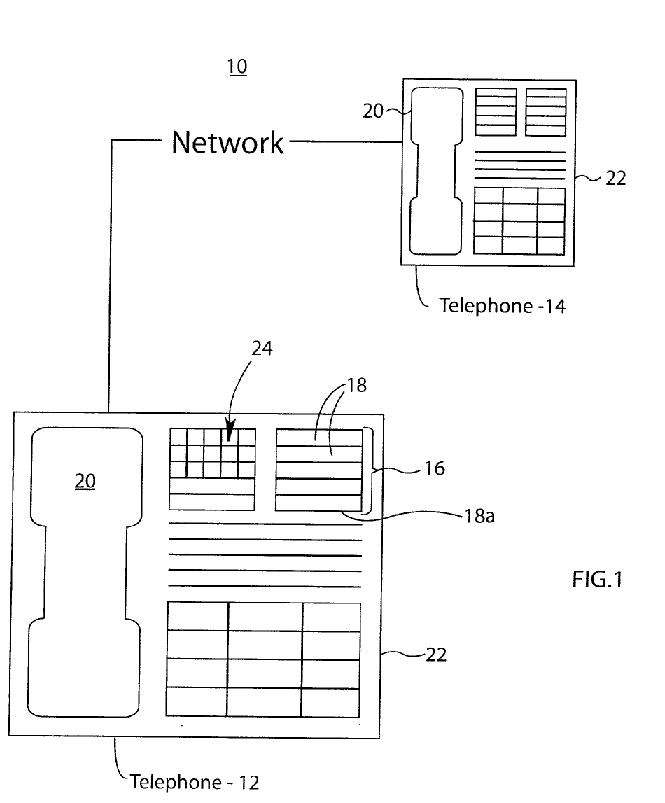

Referring now in specific detail to the drawings in which like reference numerals identify similar or identical elements throughout the several views, and initially to FIG. 1, a telephone network 10 is employed to route calls between telecommunications devices 12 and 14 (shown as telephones). Telecommunications devices 12 and 14, preferably transceivers, may include wired telephones, wireless telephones, TTY telephones, computers or any other device, which supports conversational communications. One or both of devices 12 and 14 may include a recording system 16, which includes one or more keys or buttons 18 to program and/or control recording device 16. Buttons 18 may include a record button, a play button a fast forward button, a pause button, a rewind button, etc. These buttons 18 provide a user with different functions for playing back a recorded conversation. Recording system 16 is preferably integrated in device 12 (and/or 14) in accordance with the present invention.

After a telephone connection is made between devices 12 and 14, the user of device 12 decides to record the conversation or a portion thereof. A record button 18a may be pressed to perform this. Alternately, a user may program a speech command into system 16, such as “record this” to enable the record system 16 to record the conversation. Other speech commands may also be employed and programmed for other tasks as well, for example, stop recording or playback. In another embodiment, the present invention may include an automatic recording feature where all calls are recorded automatically.

Advantageously, by implementing the present invention, telephones include a non-volatile memory, which may be similar to number storage memory for telephones. A handset 20 or a base 22 may include record button 18a, which when pressed will record the telephonic conversation. Flexibility will be given to the user to either manually press this button as he/she is speaking to record a conversation, or to set recording preferences as desired (e.g., automatic record). The user may then note needed information by listening to the recording after the call is completed. A speaker 24 on base 22 or in handset 20 may be employed to playback the recording. The recording may be played back while the phone is on-hook or off-hook.

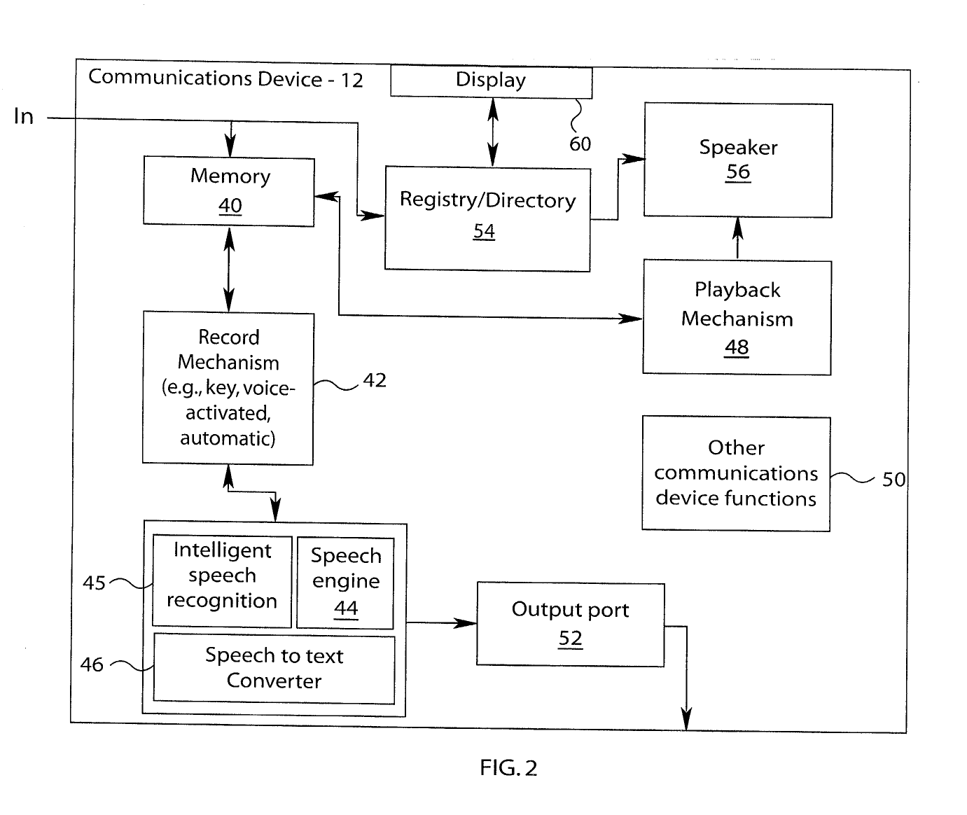

Referring to FIG. 2, a block diagram of a communication device 12 (or 14) including the present invention is shown. Device 12 includes memory storage 40, which preferably includes an erasable programmable memory device, such as a non-volatile memory. Memory 40 is programmed or recorded to when a record mechanism 42 is activated. Record mechanism 42 may include a hardware mechanism such as a key or button, or include a software mechanism supported by a speech recognition engine 44. Speech recognition engine 44 is trained for basic recording device commands, such as “record”, “play”, “fast forward”, “rewind”, etc. Speech recognition engine 44 is preferably trained with the voices of one or more users of device 12. Speech recognition engine 44 may also be employed as a security feature. For example, biometric data may be stored or a key phrase used to enable recording and/or playback of recorded materials. Biometric data may include speech patterns, pronunciations, or other acoustic features to ensure proper identification of a user.

Speech engine 44 may include a speech to text converter 46, which may be employed to transcribe recorded conversations. Converted text may be output to a computer, printer or other device through output port 52.

Another embodiment of the present invention may include an intelligent voice recognition system(s) 45 in speech engine 44. System 45 may be programmed to automatically record a telephone number, address or other such pertinent information automatically into the address book registry of device 12. The system's voice recognition system 45 recognizes characters (numbers) being spoken by the other party, automatically filter them and record the information into the non-volatile address book memory registry in memory 40. The user may configure what the system records, for example, numbers only, names and numbers, or the user may simply manually press of a record key to record the selected information.

Intelligent voice recognition 45 automatically records specifically identified information into a memory registry 54. Feedback (e.g., audible feedback via speaker 56 or visual feedback via display 60) is preferably given to the user as to where in memory registry 54 the information has been recorded after the call is over. This will assist the user in locating this newly recorded piece of information for future use. The system can be further enhanced by including in memory 40 features like password protected access to the recordings to ensure privacy, multiple user settings and multiple user profiles within a household, multiple conversation boxes (memory locations) for each user to record their respective calls in their own memory locations etc.

Device 12 includes a speaker 56, which may include a handset speaker or speaker associated with, for example, a speaker telephone. Speaker 56 acoustically renders information from memory 40 when a playback mechanism 48 is activated. Device 12 also includes other functions 50 employed in conventional telephone or communications devices.

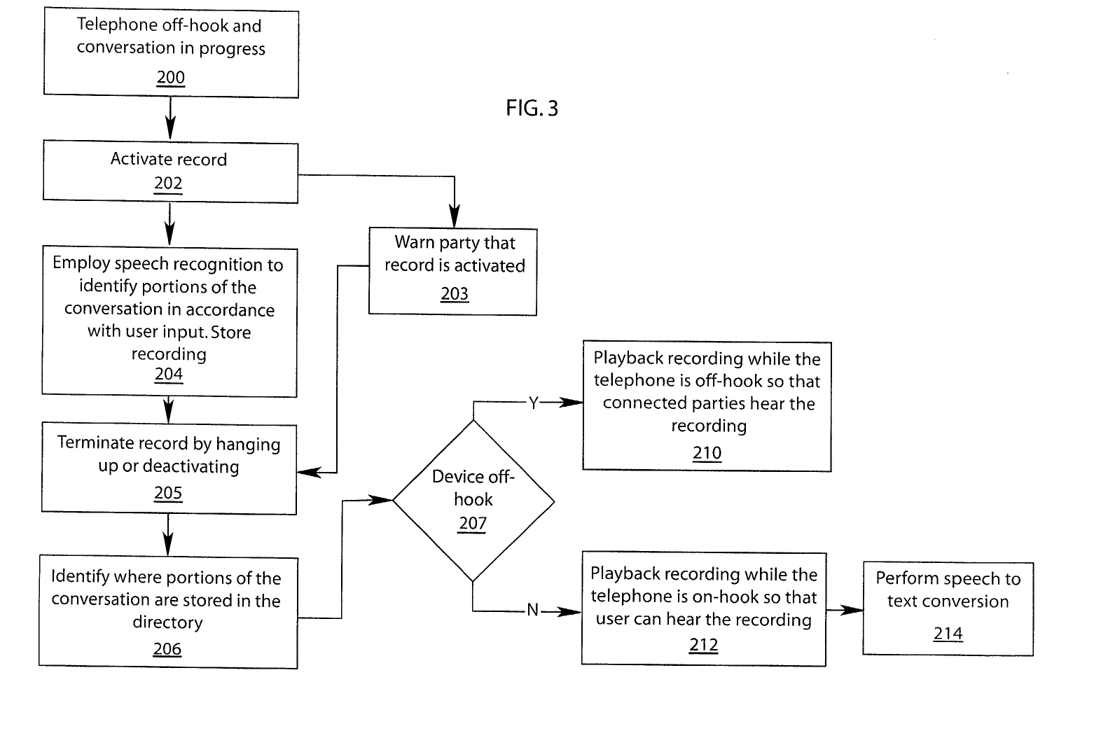

Referring to FIG. 3, a flow diagram illustratively showing a method for employing the present invention is provided. In block 200, a telephone conversation is in progress with the telephone off-hook. During the conversation or prior to the conversation, a record mechanism is activated in block 202. This may be performed by activating a manual switch, voice command or setting an automatic recording option. If needed, the party on the other end of the connection is warned that the conversation is being recorded, in block 203. This may be provided by a prerecorded message voice stored in memory. In block 204, voice recognition may be employed to identify important characteristics of the phone conversation. For example, telephone numbers and names may be identified and stored in a directory.

In block 205, the recording session is terminated with the termination of the phone call or by deactivating the record mechanism. When terminated a file name or memory location where the recording is stored is identified on a display or rendered acoustically though a speaker, in block 206.

In block 207, if the recorder is deactivated and the phone is still off-hook, then the recording can be played back so that both parties to the connection can hear the recording. This is performed in block 210. In block 212, the recording may be played back while the telephone is on-hook. In block 214, speech to text conversion may be performed in accordance with the present invention.

Having described preferred embodiments for a manual and automatic record feature in a telephone (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A communications device, comprising a transceiver coupled to a telecommunications network for transmitting and receiving conversational communications;
a recording device integrated into the transceiver, which can be activated in real-time to record the conversational communications, such that the conversational communications can be played back while the transceiver is on-hook or off-hook; and
a record activation device integrated into the transceiver to permit the activation of the recording device to selectively record portions of the conversational communications.

2. The device as recited in claim 1, wherein the transceiver includes a telephone.

3. The device as recited in claim 1, wherein the recording device includes an erasable programmable memory.

4. The device as recited in claim 1, wherein the record activation device includes a mechanical switch.

5. The device as recited in claim 4, wherein the mechanical switch is included on a handset of a telephone.

6. The device as recited in claim 4, wherein the mechanical switch is included on a base portion of a telephone.

7. The device as recited in claim 1, further comprising a speech recognition engine wherein the record activation device includes a voice activated record command.

8. The device as recited in claim 7, wherein the speech recognition engine identifies specific portions of speech in the conversational communications and stores the specific portions in a memory location.

9. The device as recited in claim 8, wherein the specific portions of speech include at least one of numbers and names, and the memory location includes a directory.

10. The device as recited in claim 1, wherein the record activation device includes an automatic mode, which records the conversational communications.

11. The device as recited in claim 1, further comprising a speech to text converter for outputting text for the conversational communications.

12. The device as recited in claim 1, further comprising a display for displaying recorded text converter.

13. A method for recording a telephone conversation, comprising the steps of:
activating a recording device, which is integrated into a telephone to record a two-way conversation;
identifying specific portions of the conversation being recorded by employing a speech recognition engine to automatically identify the portions based on pre-selected speech criteria; and
storing the specific portions of the conversation in memory locations.

14. The method as recited in claim 13, wherein the step of identifying specific portions of the conversation includes identifying at least one of names and numbers.

15. The method as recited in claim 13, wherein the step of storing the specific portions of the conversation in memory locations includes storing the specific portions in a directory of entries.

16. The method as recited in claim 13, wherein the step of activating a recording device includes activating the recording device by pressing a button.

17. The method as recited in claim 13, wherein the step of activating a recording device includes activating the recording device by a voice activated command.

18. The method as recited in claim 13, further comprising the step of warning a party that the recording device has been activated.

19. The method as recited in claim 13, further comprising the step of playing back recordings while the telephone is on-hook or off-hook.
